(19) United States
(12) Patent Application Publication
(10) Pub. No.: US 2002/0167144 A1
(43) Pub. Date: Nov. 14, 2002

(54) Steering control mechanism for kick scooter

(76) Inventor: Lee Guang-Gwo, Taipei (TW)

Correspondence Address: Donald C. Casey, Suite 100, 311 North Washington Street, Alexandria, VA, 22314, US

(21) Appl. No.: 09/850,159

(22) Filed: May 8, 2001

(51) Int. Cl. B62M 1/00; B62B 3/02

(52) U.S. Cl. 280/87.041

(57) ABSTRACT

A steering control mechanism for kick scooter includes a footplate having a fixed front mount, a steering bracket mounted on the front mount, two pins bilaterally provided at the steering bracket, two front wheels, two joints connected between the pins and the front wheels, and a track bar coupled between the joints, wherein the mount comprises a forwardly extended center bearing axle, which supports the steering bracket for enabling the steering bracket to be turned about the bearing axle; the front mount and the steering bracket form a transmission mechanism adapted to transmit biased pressure from the rider to the front wheels; the pins are respectively disposed in an oblique direction relative to the footplate and perpendicular to the forward rotation direction of the front wheels.

### BACKGROUND OF THE INVENTION

The present invent to kick scooters and, more specifically, to a steering control mechanism for kick scooter in which a steering bracket coupled to a bearing axle is turned about a bearing axle at the front side of the footplate to hold two front wheels, and a track bar is coupled to a rod member at the front side of the footplate by a slip joint and connected between two joints that couple the front wheels to the steering bracket.

A conventional kick scooter, as described in patent WO 00/03773A1, comprises two steering joints adapted to control the tilting of the front wheels. When a biased pressure is given to one side of the footplate, the steering joints are forced to tilt the front wheels in one direction. When the load to the footplate is biased to one side, the torsional force given by the joints to the pins to which the joints are coupled is relatively increased. On the contrary, the torsional force is relatively reduced when the biased pressure is reduced. This structure of steering control design has drawbacks. Because the front wheels are forced to tilt outwards relative to the curve along which the kick scooter is moved, the rider cannot accurately control the steering of the kick scooter. Further, this design simply uses a return spring to return the steering bracket after a direction change.

U.S. Pat. No. 6,158,752A discloses another structure of steering control mechanism for kick scooter. According to this design, each wheel transmission axle is turned about a vertical axis; the footplate comprises an upper plate having a vertical bottom pivot bolt, and a bottom plate coupled to the vertical bottom pivot bolt of the upper plate. Further, the upper plate comprises a cam coupled to the bottom plate, and a track bar adapted to couple the cam to the joints that control the tilting of the front wheels. This design complicates the structure of the footplate. Further, the design of the joints cannot stop the front wheels from biasing sideways when the rider changes the steering direction of the kick scooter.

### SUMMARY OF THE INVENTION

The present invention has been accomplished to provide a kick scooter steering mechanism, which eliminates the aforesaid drawbacks. It is the main object of the present invention to provide a kick scooter steering mechanism, which enables the front wheels to be synchronously tilted when the rider tilts the footplate of the kick scooter in one direction. According to one aspect of the present invention, the steering control mechanism for kick scooter comprises a footplate having a fixed front mount, a steering bracket mounted on the front mount, two pins bilaterally provided at the steering bracket, two front wheels, two joints connected between the pins and the front wheels, and a track bar coupled between the joints, wherein the mount comprises a forwardly extended center bearing axle, which supports the steering bracket for enabling the steering bracket to be turned about the bearing axle; the front mount and the steering bracket form a transmission mechanism adapted to transmit biased pressure from the rider to the front wheels; the pins are respectively disposed in an oblique direction relative to the footplate and perpendicular to the forward rotation direction of the front wheels. According to another aspect of the present invention, the track bar comprises a vertical sliding slot disposed on the middle and coupled to a rod member of the front mount. According to still another aspect of the present invention, the distance between the rod member and the bearing axle is adjustable. According to still another aspect of the present invention, a cam is provided between the steering bracket and the front mount, and a return spring is provided to impart a pressure to the steering bracket toward the front mount.

### BRIEF DESCRIPTION OF THE DRAWINGS

FIG. 1 is a top plain view of a steering control mechanism for kick scooter constructed according to the present invention.

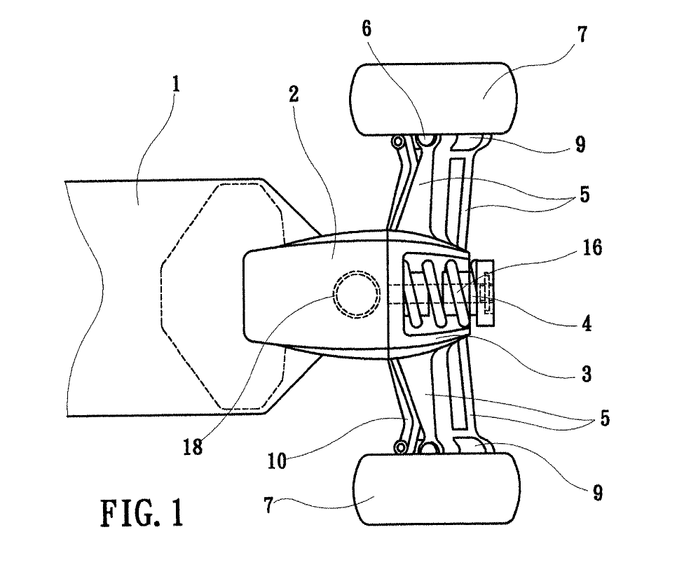

FIG. 2 is a side plain view of the steering control mechanism for kick scooter according to the present invention.

FIG. 3 is a front plain view of the steering control mechanism for kick scooter according to the present invention.

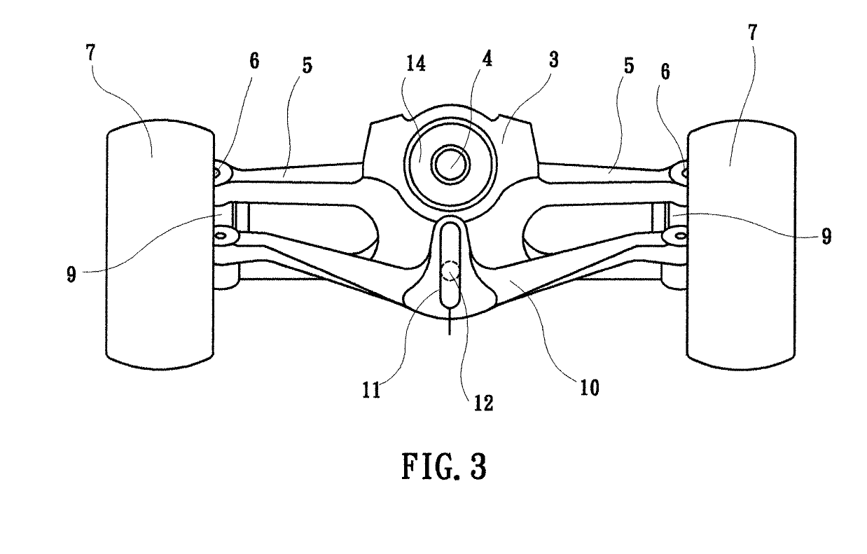

### DETAILED DESCRIPTION OF THE PREFERRED EMBODIMENT

Referring to FIGS. from 1 through 3, a steering control mechanism for a folding collapsible kick scooter in accordance with the present invention is generally comprised of a footplate 1, a mount 2 fixedly fastened to the front side of the footplate 1, a bearing axle 4 mounted in the mount 2 in direction parallel to the footplate 1, a steering bracket 3 turned about the bearing axle 4, the steering bracket 3 having two arms 5 extended from two opposite lateral sides thereof in reversed directions, each arm 5 having a pin 6 on it, two front wheels 7, two steering joints 9 each having one end pivoted to the pin 6 at one arm 5 and an opposite end connected to the wheel axle 8 of one front wheel 7, a track bar 10 coupled between the joints 9, the track bar 10 having a vertical sliding slot 11 on the middle, and a rod member 12 mounted in the mount 2 in direction parallel to the bearing axle 4 and inserted into the sliding slot 11 of the track bar 10. When a biased pressure is given to the footplate 1 to force the steering bracket 3 to turn about the bearing axle 4 in one direction, the rod member 12 is driven to move the track bar 10, thereby causing the front wheels 7 to be biased to one direction.

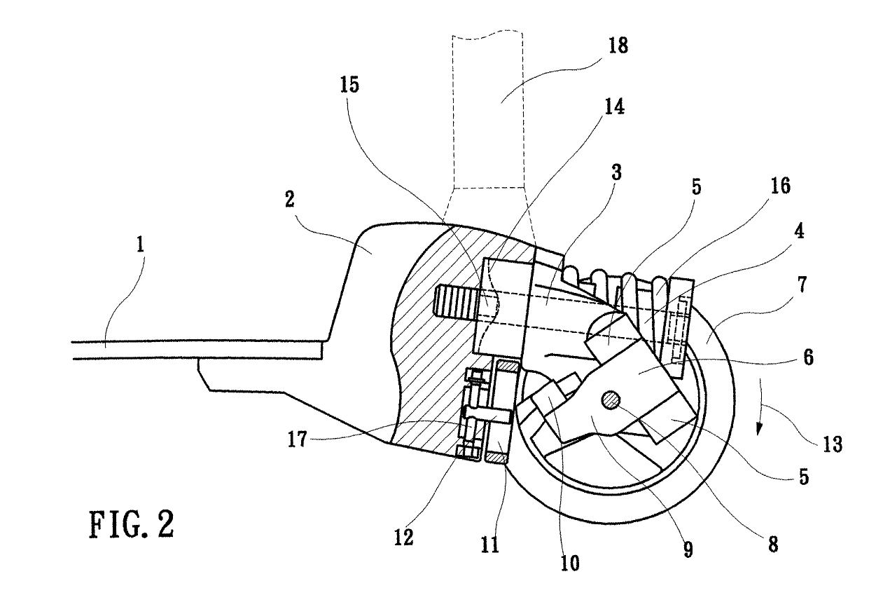

Referring to FIG. 2, the pin 6 is disposed in an oblique direction relative to the footplate and perpendicular to the forward rotation direction of the front wheels 7. Therefore, when the joints 9 are biased, the front wheels 7 are constrained to be turn about a vertical axis as well as a longitudinal axis, so that the front wheels 7 can be tilted in direction toward the inner side of the curve along which the kick scooter is moved.

In order to let the front wheels 7 be automatically returned to the center position to move straightly ahead, a guide block 15 is fixedly provided in the mount 2, a cam 14 is fixedly provided in the steering bracket 3 and disposed in contact with the guide block 15, and a return spring 16 is mounted on the bearing axle 4 and adapted to impart a pressure to the steering bracket 3 toward the mount 2. When the mount 2 is turned with the footplate 1 in one direction relative to the steering bracket 3, the spring force of the return spring 16 and the effect of the cam 14 force the steering bracket 3 to move on the bearing axle 4 in radial direction. During movement of the steering bracket 3, the return spring is forced to preserve energy for returning the steering bracket 3. An adjustment screw may be used to adjust the spring power of the return spring 16.

Referring to FIG. 2, the rod member 12 is not fixedly fastened to the mount 2. The distance between the rod member 12 and the bearing axle 4 is adjustable. A worm gear 17 is mounted in the mount 2 and threaded into a radial screw hole (not shown) in the rod member 12. Following the change of the distance between the rod member 12 and the bearing axle 4 and the turning of the mount 2 with the footplate 1 relative to the steering bracket 3, the rod member 12 and the track bar 10 are forced to bias the front wheels 7.

Further, an upright steering control column 18 is mounted on the mount 2 at the topside for controlling the tilting of the footplate 1. Preferably, the steering control column 18 can be alternatively locked in the operative position, or turned downwards to the footplate and locked in the non-operative position to reduce the storage space.

A prototype of steering control mechanism for folding collapsible kick scooter has been constructed with the features of the annexed drawings. The steering control mechanism for folding collapsible kick scooter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A steering control mechanism for kick scooter comprising a footplate having a fixed front mount, a steering bracket mounted on said front mount, two pins bilaterally provided at said steering bracket, two front wheels, two joints connected between said pins and said front wheels, and a track bar coupled between said joints, wherein said mount comprises a forwardly extended center bearing axle, which supports said steering bracket for enabling said steering bracket to be turned about said bearing axle; said front mount and said steering bracket form a transmission mechanism adapted to transmit biased pressure from the rider to said front wheels; said pins are respectively disposed in an oblique direction relative to said footplate and perpendicular to the forward rotation direction of said front wheels.

2. The steering control mechanism for kick scooter of claim 1 wherein said track bar comprises a vertical sliding slot disposed on the middle and coupled to a rod member of said front mount.

3. The steering control mechanism for kick scooter of claim 2 wherein the distance between said rod member and said bearing axle is adjustable.

4. The steering control mechanism for kick scooter of claim 1 wherein a cam is provided between said steering bracket and said front mount and a return spring is provided to impart a pressure to said steering bracket toward said front mount.
